(19) United States
(12) Patent Application Publication
(10) Pub. No.: US 2017/0116948 A1
(43) Pub. Date: Apr. 27, 2017

(54) DISPLAY APPARATUS AND METHOD FOR DRIVING PIXEL THEREOF

(71) Applicant: AU Optronics Corporation, HSIN-CHU (TW)

(72) Inventors: Chun-Kuei WEN, HSIN-CHU (TW); Chun-Yu CHEN, HSIN-CHU (TW); Yu-Ting HUANG, HSIN-CHU (TW); Hung-Min SHIH, HSIN-CHU (TW)

(21) Appl. No.: 15/059,345

(22) Filed: Mar. 3, 2016

(30) Foreign Application Priority Data
Oct. 26, 2015 (TW) 104135029

(51) Int. Cl. G09G 3/36

(52) U.S. Cl. CPC G09G 3/3685

(57) ABSTRACT

A display apparatus and a method for driving pixel thereof are provided. The display apparatus includes a source driver, a plurality of data lines and a plurality of pixels. The source driver receives a polarity signal and a frame switching signal and has a plurality of data channels. The data channels alternately provide a plurality of first pixel voltages with a first drive capability and a plurality of second pixel voltages with a second drive capability according to the polarity signal. Each of the data channels alternatively outputs the corresponding first pixel voltage and the corresponding second pixel voltage. The data lines are coupled to the source driver to receive the first pixel voltages and the second pixel voltages. The pixels are coupled to the data lines to receive the corresponding first pixel voltage or the corresponding second pixel voltage.

### TECHNICAL FIELD

The present invention relates to a display technology, and in particular, to a display apparatus and method for driving pixels thereof.

### BACKGROUND ART

Due to properties such as low power consumption, low radiation, light weight and thin shapes, LCD displays have become important and highly used electronic products. In addition, with continued advances in technology, the frame resolution of LCD display apparatuses continues to improve, resulting in an increase in power consumption. Thus, reducing power consumption of a display apparatus without affecting the display quality has become an important objective.

### SUMMARY OF THE PRESENT INVENTION

The present invention provides a display apparatus and method for driving pixels thereof, by which the power consumption of a display apparatus may be reduced.

The display apparatus of embodiments of the present invention includes a source driver, a plurality of data lines and a plurality of pixels. The source driver receives a polarity signal and a frame switching signal and has a plurality of data channels. The data channels alternately provide a plurality of first pixel voltages and a plurality of second pixel voltages according to the polarity signal, wherein each of the data channels alternatively outputs the corresponding first pixel voltage and the corresponding second pixel voltage according to the polarity signal and the frame switching signal. The first pixel voltages have a first drive capability, and the second pixel voltages have a second drive capability. The data lines are coupled to the source driver, for receiving the first pixel voltages and the second pixel voltages. The pixels are coupled to the data lines to receive the corresponding first pixel voltage or the corresponding second pixel voltage.

The pixel driving method according to embodiments of the present invention is suitable for a plurality of pixels coupled to a source driver, and includes the steps of: providing a plurality of data channels through the source driver, to alternately provide a plurality of first pixel voltages and a plurality of second pixel voltages, wherein each of the data channels alternatively outputs the corresponding first pixel voltage and the corresponding second pixel voltage according to a polarity signal and a frame switching signal, the first pixel voltages have a first drive capability, and the second pixel voltages have a second drive capability; and providing a plurality of data lines to transmit the first pixel voltages and the second pixel voltages to the pixels.

According to the display apparatus and method for driving pixels thereof of embodiments of the present invention, the data channels thereof alternatively output the first pixel voltages having the first drive capability and the second pixel voltages having the second drive capability to the pixels according to the polarity signal and the frame switching signal. As such, the formation of differences in drive capabilities of writing frames can be prevented and the power consumption for writing frames can be reduced.

To assist in the understanding of the present invention, the following embodiments are described in detail in conjunction with accompanying figures.

### BRIEF EXPLANATION OF DRAWINGS

FIG. 1A is a schematic diagram of a system of a display apparatus according to a first embodiment of the present invention.

FIG. 1B to FIG. 1D are schematic diagrams of driving of a display panel according to the first embodiment of the present invention.

FIG. 2A is a schematic diagram of a system of a display apparatus according to a second embodiment of the present invention.

FIG. 2B to FIG. 2D are schematic diagrams of driving of a display panel according to the second embodiment of the present invention.

FIG. 3 is a schematic diagram of a system of a display apparatus according to a third embodiment of the present invention.

FIG. 4 is a schematic diagram of a system of a display apparatus according to a fourth embodiment of the present invention.

FIG. 5 is a schematic diagram of a system of a data channel according to an embodiment of the present invention.

FIG. 6 is a schematic diagram of a circuit of a display panel according to an embodiment of the present invention.

FIG. 7 is a flow chart of a pixel driving method according to an embodiment of the present invention.

### DETAILED DESCRIPTION OF THE INVENTION

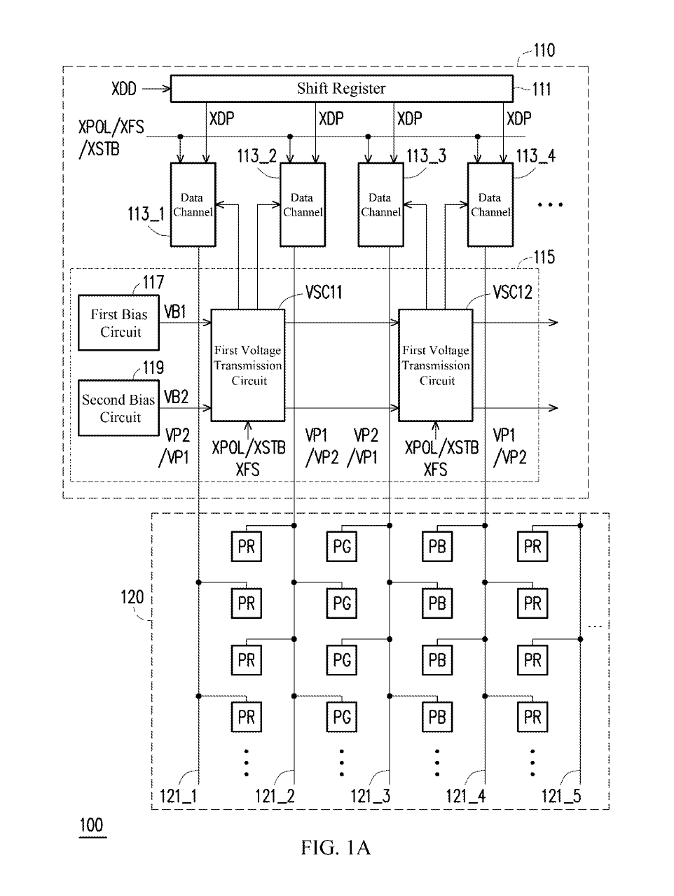

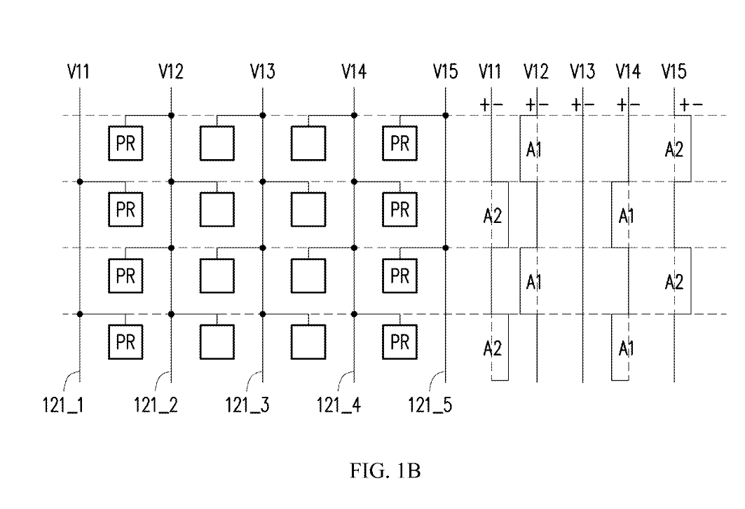

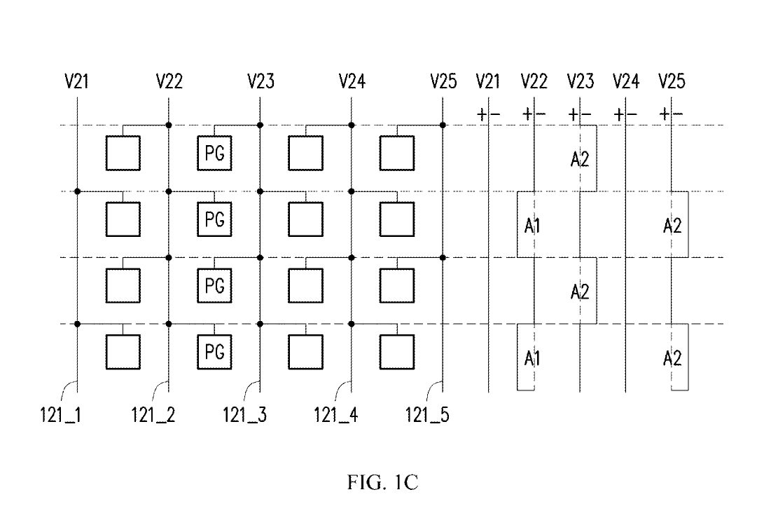

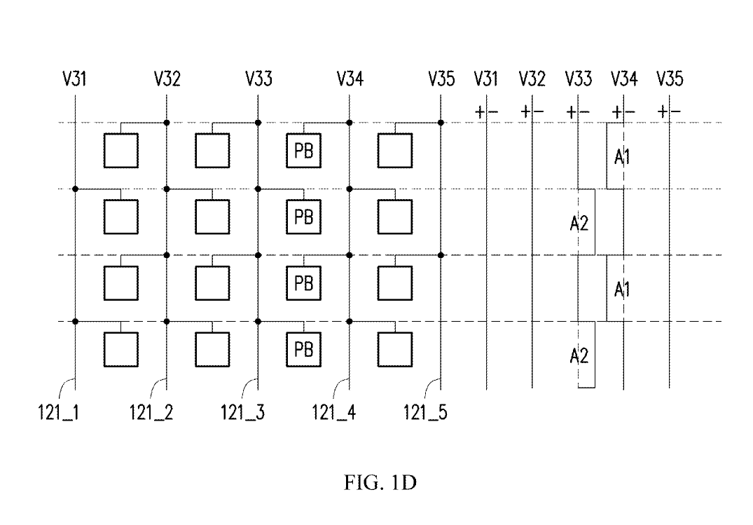

Reference is now made to FIG. 1A, which is a schematic diagram of a system of a display apparatus according to a first embodiment of the present invention. The display apparatus 100 includes a source driver 110 and a display panel 120. The source driver 110 receives a data signal XDD, a polarity signal XPOL, a frame switching signal XFS and a latch signal XSTB, to provide a plurality of first pixel voltages VP1 having a first drive capability and a plurality of second pixel voltages VP2 having a second drive capability to the display panel 120. The first pixel voltages VP1 may be pixel voltages greater than a common voltage, the second pixel voltages VP2 may be pixel voltages lower than the common voltage, and the first drive capability is, for example, lower than the second drive capability.

In the first embodiment, the frame switching signal XFS is configured to represent switching of frame periods; namely, the frame switching signal XFS may be a vertical blanking signal, but embodiments of the present invention are not limited thereto. The source driver 110 generates the first pixel voltages VP1 and the second pixel voltages VP2 according to a driving mode of column inversion; namely, the first pixel voltages VP1 and the second pixel voltages VP2 are alternately outputted, and during one frame period, each output end keeps outputting the first pixel voltage VP1 or the second pixel voltage VP2.

The source driver 110 includes a shift register 111, a plurality of data channels (such as channels 113_1 through 113_4) and a first drive capability setting unit 115. The shift register 111 receives the data signal XDD to provide a plurality of display data XDP to the data channels (such as channels 113_1 through 113_4). The data channels (such as channels 113_1 through 113_4) receive the polarity signal XPOL, the frame switching signal XFS and the latch signal XSTB, and alternately provide the first pixel voltages VP1 and the second pixel voltages VP2 according to the polarity signal XPOL; namely, two adjacent data channels of the plurality of data channels (such as 113_1 through 113_2) provide the first pixel voltage VP1 and the second pixel voltage VP2 respectively. Each of the data channels determines whether to convert the received display data XDP according to the latch signal XSTB, and each of the data channels alternatively outputs the corresponding first pixel voltage VP1 and the corresponding second pixel voltage VP2 according to the polarity signal XPOL and the frame switching signal XFS. In other words, in one frame period, each of the data channels provides the corresponding first pixel voltage VP1; in the next frame period, each of the data channels provides the corresponding second pixel voltage VP2.

The first drive capability setting unit 115 is coupled to the data channels and receives the polarity signal XPOL, the frame switching signal XFS and the latch signal XSTB, to provide a first bias VB1 and a second bias VB2 to the data channels, wherein the first bias VB1 is configured to set the first pixel voltages VP1 to have the first drive capability, and the second bias VB2 is configured to set the second pixel voltages VP2 to have the second drive capability. As used herein, the term “coupled” means either a direct electrical connection, or an electrical connection through one or more intermediary components which intermediary components don't have an appreciable impact on the electrical signal.

Furthermore, the first drive capability setting unit 115 includes a first bias circuit 117, a second bias circuit 119 and a plurality of first voltage transmission circuits (such as VSC11, VSC12). The first bias circuit 117 is configured to provide the first bias VB1. The second bias circuit 119 is configured to provide the second bias VB2. The first voltage transmission circuits (VSC11, VSC12) receive the polarity signal XPOL, the latch signal XSTB and the frame switching signal XFS, and are respectively coupled to the first bias circuit 117, the second bias circuit 119 and disposed between two adjacent data channels of the plurality of data channels (i.e., 113_1 through 113_4). According to the polarity signal XPOL, the latch signal XSTB and the frame switching signal XFS, each of the first voltage transmission circuits (VSC11, VSC12) transmits the first bias VB1 and the second bias VB2 to two adjacent data channels of the plurality of data channels respectively.

The display panel 120 includes a plurality of data lines (such as data lines 121_1 through 121_5) and a plurality of pixels (such as red pixels PR, green pixels PG and blue pixels PB). The data lines (121_1, 121_5) are coupled to the source driver 110, for receiving the first pixel voltages VP1 and the second pixel voltages VP2. The pixels (such as PR, PG and PB) are coupled to the data lines (121_1, 121_5121_1 through 121_5) to receive the corresponding first pixel voltage VP1 or the corresponding second pixel voltage VP2. In the present embodiment, the pixels (such as PR, PG and PB) and the data lines (121_1, 121_5121_1 through 121_5) are coupled to each other in a Z-shaped pixel arrangement; namely, the pixels (such as PR, PG and PB) to which each of the data lines (121_1, 121_5121_1 through 121_5) is coupled are located in two adjacent columns of pixels, and the pixels (such as PR, PG and PB) to which each of the data lines (121_1, 121_5121_1 through 121_5) corresponds are located in different rows and not adjacent to each other.

For example, in a first frame period, the data channels (113_1 through 113_4) provide the first pixel voltages VP1 to the pixels (such as PR, PG and PB) respectively through even data lines (such as 121_2, 121_4, corresponding to first data lines) in the data lines (121_1, 121_5121_1 through 121_5) according to the polarity signal XPOL and the frame switching signal XFS, and the data channels (113_1 through 113_4) provide the second pixel voltages VP2 to the pixels (PR, PG and PB) respectively through odd data lines (such as 121_1, 121_3, 121_5, corresponding to second data lines) in the data lines (121_1, 121_5121_1 through 121_5) according to the polarity signal XPOL and the frame switching signal XFS. In a second frame period following the first frame period, the data channels (113_1 through 113_4) provide the second pixel voltages VP2 to the pixels (PR, PG and PB) respectively through the even data lines (such as 121_2, 121_4) according to the polarity signal XPOL and the frame switching signal XFS, and the data channels (113_1 through 113_4) provide the first pixel voltages VP1 to the pixels (PR, PG and PB) respectively through the odd data lines (such as 121_1, 121_3, 121_5) according to the polarity signal XPOL and the frame switching signal XFS. In accordance with the above, the first data lines are different from the second data lines in embodiments of the present invention.

In embodiments of the present invention, the display apparatus 100 may further include a timing controller (not shown) and a gate driver (not shown), and the display panel 120 may further comprise scan lines. The scan lines are coupled to the gate driver and the corresponding pixels (PR, PG and PB), to drive the pixels (PR, PG and PB) row by row. The gate driver is controlled by the timing controller to provide a gate signal to the scan lines, and the source driver 110 is controlled by the timing controller to provide the first pixel voltages VP1 or the corresponding second pixel voltages VP2 to the data lines (121_1, 121_5121_1 through 121_5); namely, the timing controller can provide the data signal XDD, the polarity signal XPOL, the frame switching signal XFS and the latch signal XSTB to the source driver 110.

FIG. 1B to FIG. 1D are schematic diagrams of driving of a display panel according to the first embodiment of the present invention. Referring to FIG. 1A to FIG. 1D, in the present embodiment, it is assumed that red frames, green frames and blue frames are written in a time-division manner, the first pixel voltages VP1 of positive polarity have a lower first drive capability A1 (for example, a drive capability of 62.5%), and the second pixel voltages VP2 of negative polarity have a higher second drive capability A2 (for example, a drive capability of 100%).

Referring to FIG. 1B, in displaying red frames, the red pixels PR are written with the corresponding pixel voltages (such as the first pixel voltages VP1 or the second pixel voltages VP2), and the remaining pixels (such as green pixels PG and blue pixels PB) are written with black data (i.e., pixel voltages corresponding to a grayscale value of 0). Furthermore, the odd data lines (such as 121_1, 121_3, 121_5), for example, receive the corresponding second pixel voltages VP2 with driving waveforms of the data lines 121_1, 121_3, 121_5 shown by V11, V13, V15; the even data lines (such as 121_2, 121_4), for example, receive the corresponding first pixel voltages VP1 with driving waveforms of the data lines 121_1, 121_3, 121_5 shown by V12, V14.

Referring to FIG. 1C, in displaying green frames, the green pixels PG are written with the corresponding pixel voltages (such as the first pixel voltages VP1 or the second pixel voltages VP2), and the remaining pixels (such as red pixels PR and blue pixels PB) are written with black data. Driving waveforms of the odd data lines 121_1, 121_3, 121_5 are shown by V21, V23, V25, and driving waveforms of the even data lines 121_2, 121_4 are shown by V22, V24.

Referring to FIG. 1D, in displaying blue frames, the blue pixels PB are written with the corresponding pixel voltages (such as the first pixel voltages VP1 or the second pixel voltages VP2), and the remaining pixels (such as red pixels PR and green pixels PG) are written with black data. Driving waveforms of the odd data lines 121_1, 121_3, 121_5 are shown by V31, V33, V35, and driving waveforms of the even data lines 121_2, 121_4 are shown by V32, V34.

In accordance with the above, the writing of the red frames, the green frames and the blue frames all make use of the first pixel voltages VP1 and the second pixel voltages VP2; namely, the drive capabilities in writing the red frames, the green frames and the blue frames are generally the same, and thus the differences in drive capabilities are prevented from affecting the display of frames. The writing of the red frames, the green frames and the blue frames each use the first pixel voltages VP1 having a lower drive capability, and thus power consumption for writing frames is reduced.

In addition, in certain embodiments, the form of the data channels (113_1 through 113_4) is an electrical property affecting the pixel voltages (such as the first pixel voltages VP1 and the second pixel voltages VP2). For example, when the data channels (113_1 through 113_4) are formed of NMOS transistors, the first pixel voltages VP1 (here, pixel voltages greater than a common voltage) have a rise time of 0.96 μs and a fall time of 1.22 μs, and the second pixel voltages VP2 (here, pixel voltages less than the common voltage) have a rise time of 1.28 μs and a fall time of 0.98 μs. As described above, the rise times (i.e., charging capabilities) of the first pixel voltages VP1 and the second pixel voltages VP2 are different from each other, and thus the charging capabilities of the first pixel voltages VP1 and the second pixel voltages VP2 can be made generally the same through adjustments of the drive capabilities, so as to prevent frames from flickering, thereby improving the quality of frames.

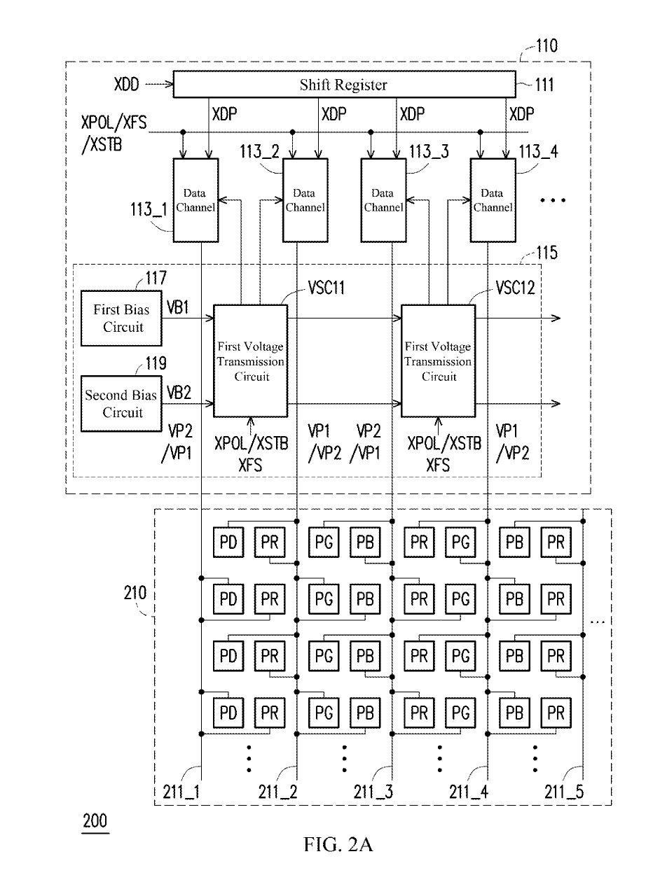

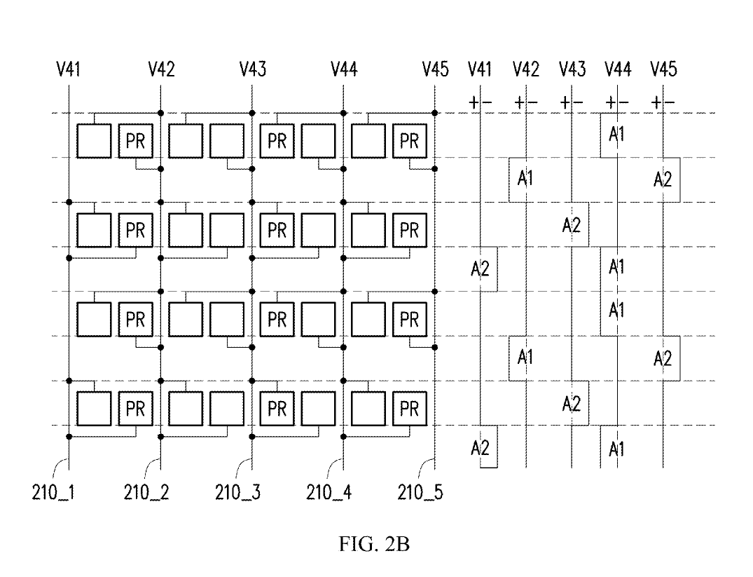

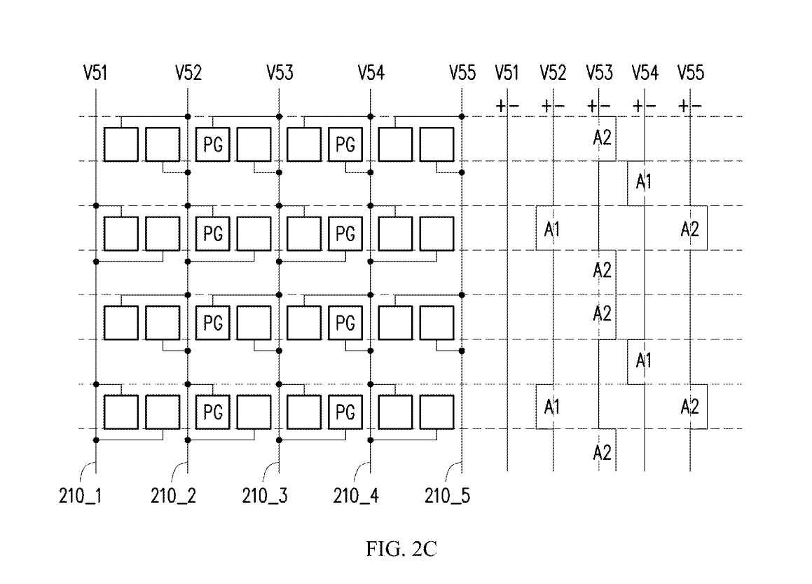

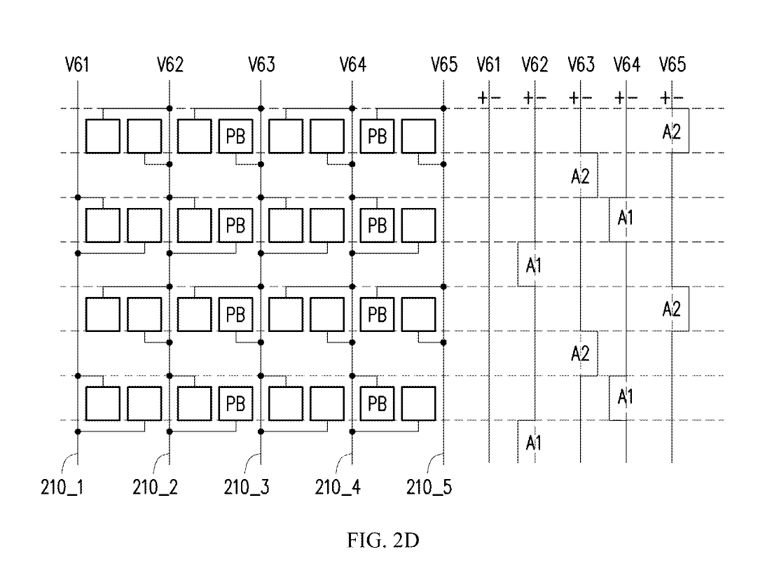

FIG. 2A is a schematic diagram of a system of a display apparatus according to a second embodiment of the present invention. Referring to FIG. 1A and FIG. 2A, in the present embodiment, the display apparatus 200 is generally the same as the display apparatus 100 except for the display panel 210. In the present embodiment, the display panel 210 includes a plurality of data lines (such as 211_1-211_5) and a plurality of pixels (such as spare pixels PD, red pixels PR, green pixels PG and blue pixels PB). The data lines (211_1 through 211_5) are coupled to the source driver 110 for receiving the first pixel voltages VP1 and the second pixel voltages VP2. The pixels (such as PD, PR, PG and PB) are coupled to the data lines (211_1 through 221_5) to receive the corresponding first pixel voltage VP1 or the corresponding second pixel voltage VP2.

In the present embodiment, the pixels (such as PD, PR, PG and PB) and the data lines (221_1 through 221_5) are coupled to each other in a generally Z-shaped pixel arrangement; namely, the pixels (such as PD, PR, PG and PB) to which each of the data lines (221_1 through 221_5) is coupled are located in four adjacent columns of pixels. Among the pixels (PD, PR, PG and PB) to which each of the data lines (221_1 through 221_5) corresponds, those located in different rows of the pixels (PD, PR, PG and PB) are not adjacent to each other, while those located in the same rows of pixels (PD, PR, PG and PB) are adjacent to each other.

FIG. 2B to FIG. 2D are schematic diagrams of driving of a display panel according to the second embodiment of the present invention. Referring to FIG. 2A to FIG. 2D, in the present embodiment, it is again assumed that red frames, green frames and blue frames are written in a time-division manner, the first pixel voltages VP1 of positive polarity have a lower first drive capability A1 (for example, a drive capability of 62.5%), and the second pixel voltages VP2 of negative polarity have a higher second drive capability A2 (for example, a drive capability of 100%).

Referring to FIG. 2B, in displaying red frames, the red pixels PR are written with the corresponding pixel voltages (such as the first pixel voltages VP1 or the second pixel voltages VP2), and the remaining pixels (such as spare pixels PD, green pixels PG and blue pixels PB) are written with black data. Furthermore, the odd data lines (such as 211_1, 211_3, 211_5), for example, receive the corresponding second pixel voltages VP2 with driving waveforms of the data lines 211_1, 211_3, 211_5 shown by V41, V43, V45, and the even data lines (such as 221_2, 221_4), for example, receive the corresponding first pixel voltages VP1 with driving waveforms of the data lines 221_1, 221_3, 221_5 shown by V42, V44.

Referring to FIG. 2C, in displaying green frames, the green pixels PG are written with the corresponding pixel voltages (such as the first pixel voltages VP1 or the second pixel voltages VP2), and the remaining pixels (such as spare pixels PD, red pixels PR and blue pixels PB) are written with black data. Driving waveforms of the odd data lines 211_1, 211_3, 211_5 are shown by V51, V53, V55, and driving waveforms of the even data lines 211_2, 211_4 are shown by V52, V54.

Referring to FIG. 2D, in displaying blue frames, the blue pixels PB are written with the corresponding pixel voltages (such as the first pixel voltages VP1 or the second pixel voltages VP2), and the remaining pixels (such as spare pixels PD, red pixels PR and green pixels PG) are written with black data. Driving waveforms of the odd data lines 211_1, 211_3, 211_5 are shown by V61, V63, V65, and driving waveforms of the even data lines 211_2, 211_4 are shown by V62, V64.

In accordance with the above, in the generally Z-shaped pixel arrangement, the writing of the red frames, the green frames and the blue frames all make use of the first pixel voltages VP1 and the second pixel voltages VP2; namely, the drive capabilities in writing the red frames, the green frames and the blue frames are generally the same.

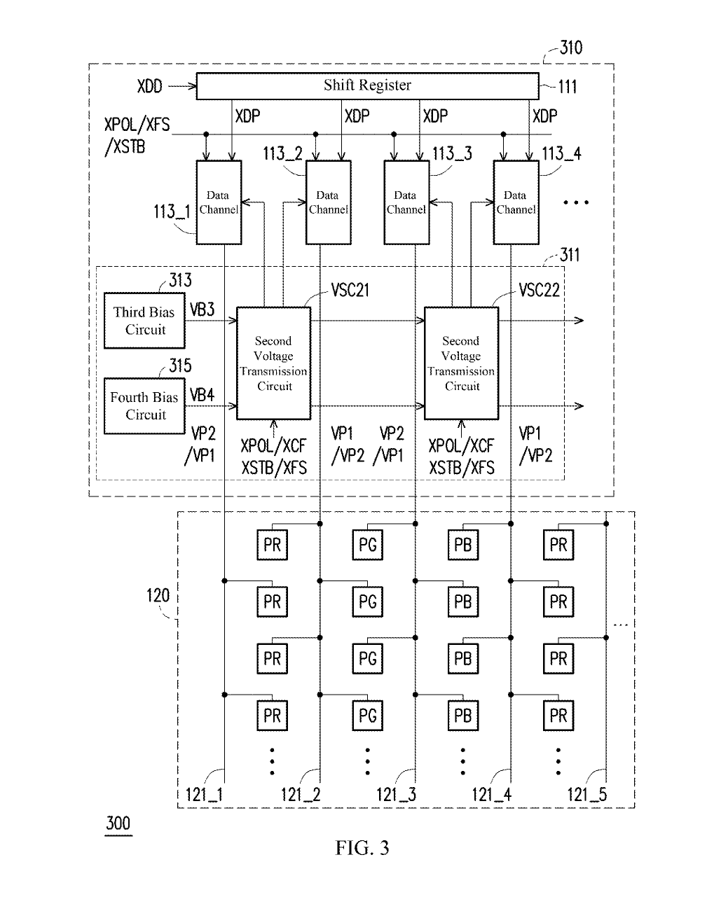

FIG. 3 is a schematic diagram of a system of a display apparatus according to a third embodiment of the present invention. Referring to FIG. 1A and FIG. 3, in the present embodiment, the display apparatus 300 is generally the same as the display apparatus 100 except for the second drive capability setting unit 311 of the source driver 310. In the present embodiment, the second drive capability setting unit 311 is coupled to the data channels (113_1 through 113_4) and receives the frame rate command XCF, the frame switching signal XFS, the polarity signal XPOL and the latch signal XSTB, to provide a third bias VB3 and a fourth bias VB4 to the data channels (113_1 through 113_4), wherein the third bias VB3 and the fourth bias VB4 are configured to set the first drive capability and the second drive capability, and the frame rate command XCF may be a G-SYNC signal defined by NVIDIA or a FreeSync signal defined by AMD; but embodiments of the present invention are not limited thereto.

When the frame rate command XCF sets the display apparatus 300 at a high frame rate mode (i.e., the frame rate of the display apparatus 300 is greater than or equal to 120 Hertz), the second drive capability setting unit 311 transmits the third bias VB3 and the fourth bias VB4 to the data channels (113_1 through 113_4) to set the first drive capability of the first pixel voltages VP1 to be lower than the second drive capability of the second pixel voltages VP2; on the contrary, when the frame rate command XCF sets the display apparatus 300 not to be at the high frame rate mode (i.e., the frame rate of the display apparatus 300 is less than 120 Hertz), the second drive capability setting unit 311 transmits one of the third bias VB3 and the fourth bias VB4 to the data channels (113_1 through 113_4) to set the first drive capability of the first pixel voltages VP1 to be equal to the second drive capability of the second pixel voltages VP2.

Furthermore, the second drive capability setting unit 311 includes a third bias circuit 313, a fourth bias circuit 315 and a plurality of second voltage transmission circuits (such as VSC21, VSC22). The third bias circuit 313 is configured to provide the third bias VB3. The fourth bias circuit 315 is configured to provide the fourth bias VB4. The second voltage transmission circuits (such as VSC21, VSC22) receive the polarity signal XPOL, the frame rate command XCF, the latch signal XSTB, and the frame switching signal XFS, and are respectively coupled to the third bias circuit 313, the fourth bias circuit 315 and disposed between two adjacent data channels of the plurality of data channels (113_1 through 113_4). When the frame rate command XCF sets the frame rate of the display apparatus 300 at greater than or equal to 120 Hertz, each of the second voltage transmission circuits (such as VSC21, VSC22) respectively transmits the third bias VB3 and the fourth bias VB4 to two adjacent data channels of the plurality of data channels (113_1 through 113_4) according to the polarity signal XPOL, the latch signal XSTB and the frame switching signal XFS; on the contrary, when the frame rate command XCF sets the frame rate of the display apparatus 300 at lower than 120 Hertz, the second voltage transmission circuits (such as VSC21, VSC22) collectively transmit one of the third bias VB3 and the fourth bias VB4 to the data channels (113_1 through 113_4).

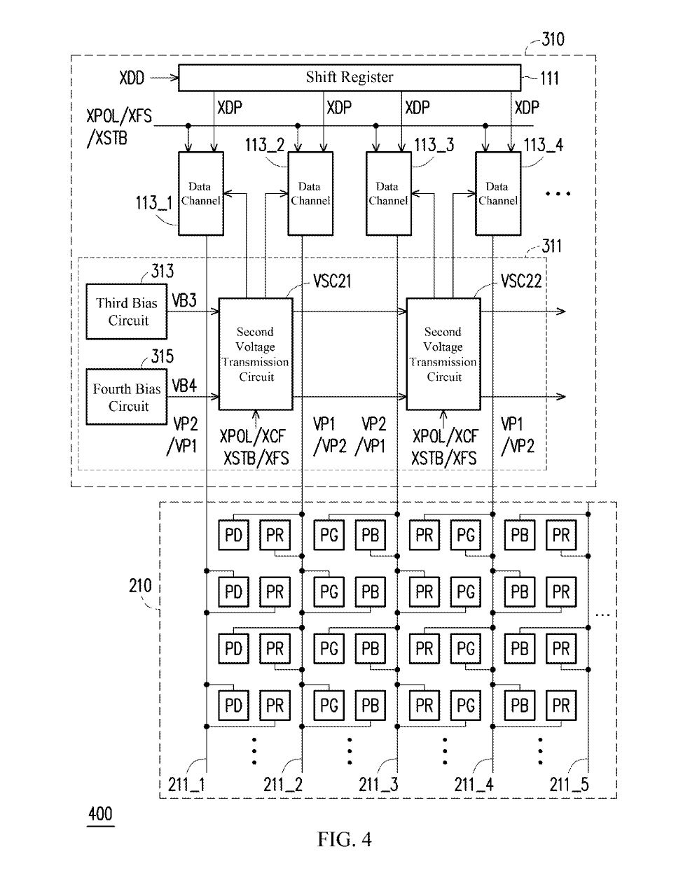

FIG. 4 is a schematic diagram of a system of a display apparatus according to a fourth embodiment of the present invention.

Referring to FIG. 2A, FIG. 3 and FIG. 4, in the present embodiment, the display apparatus 400 includes a source driver 310 and a display panel 210, wherein references can be made to the described embodiment in FIG. 2A for the display panel 210 and to the described embodiment in FIG. 3 for the source driver 310, and both are not repeatedly described herein.

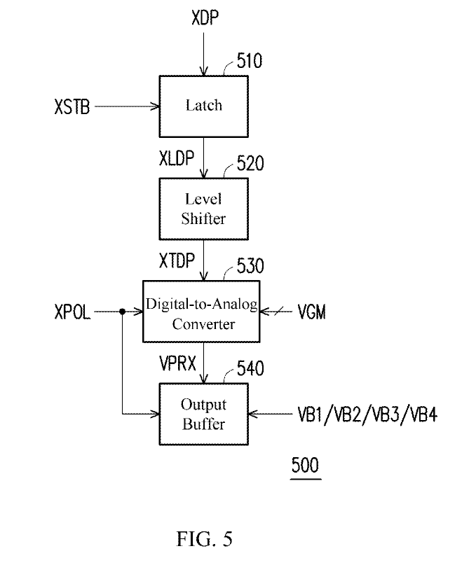

FIG. 5 is a schematic diagram of a system of a data channel according to an embodiment of the present invention. Referring to FIG. 1A, FIG. 2A, FIG. 3, FIG. 4, and FIG. 5, in the present embodiment, the data channels 113_1-113_4 may be shown by a data channel 500, and the data channel 500 includes a latch 510, a level shifter 520, a digital-to-analog converter 530 and an output buffer 540. The latch 510 receives and latches the display data XDP, and receives the latch signal XSTB to output a latch display data XLDP.

The level shifter 520 is coupled to the latch 510 to provide a to-be-converted display data XTDP according to the latch display data XLDP. The digital-to-analog converter 530 is coupled to the level shifter 520 and receives a plurality of gamma voltages VGM and the polarity signal XPOL, for converting the display data XTDP to be converted into a pixel reference voltage VPRX. The output buffer 540 is coupled to the digital-to-analog converter 530 and receives the pixel reference voltage VPRX and the polarity signal XPOL, to provide the first pixel voltages VP1 or the second pixel voltages VP2.

When the output buffer 540 is coupled to the first drive capability setting unit 115, the output buffer 540 receives the first bias VB1 or the second bias VB2; when the output buffer 540 is coupled to the second drive capability setting unit 311, the output buffer 540 receives the third bias VB3 or the fourth bias VB4. When the output buffer 540 receives the first bias VB1 and the third bias VB3, the output buffer 540 provides the first pixel voltages VP1 having the first drive capability; when the output buffer 540 receives the second bias VB2 and the fourth bias VB4, the output buffer 540 provides the second pixel voltages VP2 having the second drive capability.

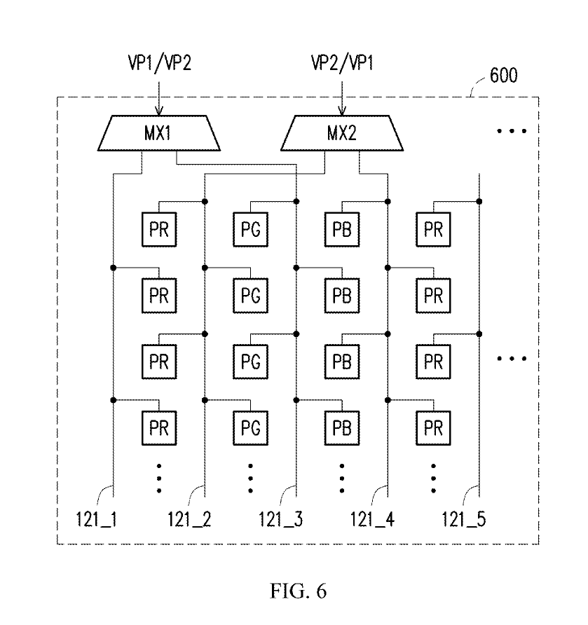

FIG. 6 is a schematic diagram of a circuit of a display panel according to an embodiment of the present invention. Referring to FIG. 1A and FIG. 6, in the present embodiment, a display panel 600 is generally the same as the display panel 120 except that the display panel 600 further includes a plurality of multiplexers (such as MX1, MX2). Each of the multiplexers (such as MX1, MX2) is coupled between the corresponding data channel (113_1 through 113_4) and the corresponding data line (121_1 through 121_5), for transmitting the first pixel voltages VP1 and the second pixel voltages VP2 to the corresponding data lines (121_1 through 121_5) sequentially, wherein the multiplexers (such as MX1, MX2) are formed of a plurality of transistors respectively.

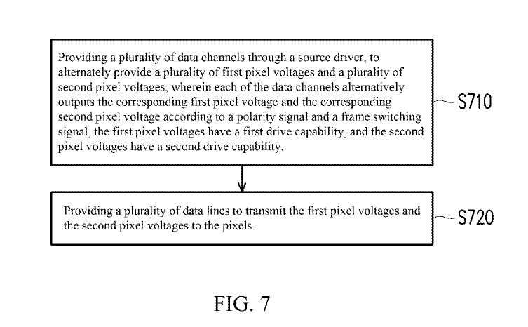

FIG. 7 is a flow chart of a pixel driving method according to an embodiment of the present invention. Referring to FIG. 7, in the present embodiment, the pixel driving method includes the following steps. Firstly, a plurality of data channels are provided through a source driver to alternately provide a plurality of first pixel voltages and a plurality of second pixel voltages, wherein each of the data channels alternatively outputs the corresponding first pixel voltage and the corresponding second pixel voltage according to a polarity signal and a frame switching signal, the first pixel voltages have a first drive capability, and the second pixel voltages have a second drive capability (step S710). Secondly, multiple data lines are provided to transmit the first pixel voltages and the second pixel voltages to a plurality of pixels (step S720). It is to be noted that the order of the steps S710 and S720 is illustrative and embodiments of the present invention are not limited thereto. Reference can be made to the described embodiments in FIG. 1A to FIG. 1D, FIG. 2A to FIG. 2D and FIG. 3 to FIG. 6 for details of the steps S710 and S720 which are not repeatedly described herein.

To sum up the above, according to the display apparatus and method for driving pixels thereof according to the embodiments of the present invention, the data channels alternatively output the first pixel voltages having the first drive capability and the second pixel voltages having the second drive capability to the display panel with a Z-shaped pixel arrangement according to the polarity signal and the frame switching signal. As such, the differences in drive capability of writing frames can be prevented from resulting in poor image quality, and the power consumption for writing frames can be reduced.

Even though the present invention has been disclosed as the abovementioned embodiments, it is not limited thereto. Any person of ordinary skill in the art may make some changes and adjustments without departing from the spirit and scope of the present invention. Therefore, the scope of the present invention is defined in view of the appended claims.

What is claimed is:

1. A display apparatus, comprising:
a source driver receiving a polarity signal and a frame switching signal and having a plurality of data channels, the plurality of data channels alternately providing a first pixel voltage and a second pixel voltage according to the polarity signal, wherein each of the plurality of data channels alternatively outputs the corresponding first pixel voltage and the corresponding second pixel voltage according to the polarity signal and the frame switching signal, the first pixel voltages have a first drive capability, and the second pixel voltages have a second drive capability;
a plurality of data lines coupled to the source driver, for receiving the first pixel voltages and the second pixel voltages; and
a plurality of pixels respectively coupled to the data lines to receive the corresponding first pixel voltage or the corresponding second pixel voltage.

2. The display apparatus according to claim 1, wherein the first pixel voltages are higher than a common voltage, the second pixel voltages are lower than the common voltage, and the first drive capability is lower than the second drive capability.

3. The display apparatus according to claim 2, wherein the source driver further comprises:
a first drive capability setting unit coupled to the data channels and receiving the polarity signal, the frame switching signal and a latch signal, to provide a first bias and a second bias to the data channels, wherein the first bias is configured to set the first pixel voltages to have the first drive capability, and the second bias is configured to set the second pixel voltages to have the second drive capability.

4. The display apparatus according to claim 3, wherein the first drive capability setting unit comprises:
a first bias circuit providing the first bias;
a second bias circuit providing the second bias; and
a plurality of first voltage transmission circuits receiving the polarity signal and the frame switching signal, coupled to the first bias circuit, the second bias circuit and the data channels, and each transmitting the first bias and the second bias respectively to two adjacent data channels of the plurality of data channels, according to the polarity signal, the frame switching signal and the latch signal.

5. The display apparatus according to claim 3, wherein each of the data channels comprises:
a latch, receiving and latching a display data and receiving the latch signal to output a latch display data;
a level shifter coupled to the latch providing a to-be-converted display data according to the latch display data;
a digital-to-analog converter coupled to the level shifter and receiving a plurality of gamma voltages and the polarity signal, for converting the to-be-converted display data into a pixel reference voltage; and
an output buffer coupled to the digital-to-analog converter and the first drive capability setting unit, and receiving the pixel reference voltage and the polarity signal to provide the first pixel voltage or the second pixel voltage, when the output buffer receives the first bias, the output buffer providing the first pixel voltage having the first drive capability, and when the output buffer receives the second bias, the output buffer providing the second pixel voltage having the second drive capability.

6. The display apparatus according to claim 1, wherein the first pixel voltages are greater than a common voltage, the second pixel voltages are lower than the common voltage, the first drive capability is lower than the second drive capability when a frame rate of the display apparatus is greater than or equal to 120 Hertz, and the first drive capability is equal to the second drive capability when the frame rate of the display apparatus is less than 120 Hertz.

7. The display apparatus according to claim 6, wherein the source driver further comprises:
a second drive capability setting unit coupled to the data channels and receiving a frame rate command, the frame switching signal, the polarity signal and a latch signal to provide a third bias and a fourth bias, wherein when the frame rate command sets the frame rate of the display apparatus at greater than or equal to 120 Hertz, the third bias and the fourth bias are transmitted to the data channels to set the first drive capability of the first pixel voltages to be lower than the second drive capability of the second pixel voltages, and when the frame rate command sets the frame rate of the display apparatus at less than 120 Hertz, one of the third bias and the fourth bias is transmitted to the data channels to set the first drive capability of the first pixel voltages to be equal to the second drive capability of the second pixel voltages.

8. The display apparatus according to claim 7, wherein the second drive capability setting unit comprises:
a third bias circuit providing the third bias;
a fourth bias circuit providing the fourth bias; and
a plurality of second voltage transmission circuits coupled to the third bias circuit, the fourth bias circuit and the data channels, wherein each of the second voltage transmission circuits transmits the third bias and the fourth bias respectively to two adjacent data channels of the plurality of data channels according to the polarity signal, the frame switching signal and the latch signal when the frame rate command sets the frame rate of the display apparatus at greater than or equal to 120 Hertz, and the second voltage transmission circuits transmit one of the third bias and the fourth bias to the data channels when the frame rate command sets the frame rate of the display apparatus at less than 120 Hertz.

9. The display apparatus according to claim 7, wherein each of the data channels comprises:
a latch, receiving and latching a display data and receiving the latch signal to output a latch display data;
a level shifter coupled to the latch providing a to-be-converted display data according to the latch display data;
a digital-to-analog converter coupled to the level shifter and receiving a plurality of gamma voltages and the polarity signal, for converting the to-be-converted display data into a pixel reference voltage; and
an output buffer coupled to the digital-to-analog converter and the second drive capability setting unit, and receiving the pixel reference voltage and the polarity signal providing the first pixel voltage or the second pixel voltage, when the output buffer receives the third bias, the output buffer providing the first pixel voltage having the first drive capability, and when the output buffer receives the fourth bias, the output buffer providing the second pixel voltage having the second drive capability.

10. The display apparatus according to claim 1, wherein in a first frame period, the data channels provide the first pixel voltages to the pixels through a plurality of first data lines of the data lines respectively according to the polarity signal and the frame switching signal, and the data channels provide the second pixel voltages to the pixels through a plurality of second data lines of the data lines respectively according to the polarity signal and the frame switching signal, and in a second frame period following the first frame period, the data channels provide the second pixel voltages to the pixels through the first data lines respectively according to the polarity signal and the frame switching signal, and the data channels provide the first pixel voltages to the pixels through the second data lines respectively according to the polarity signal and the frame switching signal, wherein the first data lines are different from the second data lines.

11. The display apparatus according to claim 10, wherein the first data lines and the second data lines are a plurality of odd data lines and a plurality of even data lines respectively.

12. The display apparatus according to claim 1, wherein the pixels to which each of the data lines is coupled are located in two columns of pixels, and the pixels to which the data lines correspond are located in different rows and are not adjacent to each other.

13. The display apparatus according to claim 1, wherein the pixels to which each of the data lines is coupled are located in four columns of pixels, the pixels located in the same row among the pixels to which the data lines correspond are adjacent to each other, and the pixels located in different rows among the pixels to which the data lines correspond are not adjacent to each other.

14. The display apparatus according to claim 1, further comprising a plurality of multiplexers coupled between the data channels and the data lines, for transmitting the first pixel voltages and the second pixel voltages to the data lines, wherein the multiplexers are respectively formed of a plurality of transistors.

15. A pixel driving method comprising:
providing a plurality of data channels through the source driver to alternately provide a plurality of first pixel voltages and a plurality of second pixel voltages, wherein each of the data channels alternatively outputs the corresponding first pixel voltage and the corresponding second pixel voltage according to a polarity signal and a frame switching signal, the first pixel voltages have a first drive capability, and the second pixel voltages have a second drive capability; and
providing a plurality of data lines to transmit the first pixel voltages and the second pixel voltages to the pixels.

16. The pixel driving method according to claim 15, wherein the first pixel voltages are greater than a common voltage, the second pixel voltages are lower than the common voltage, and the first drive capability is lower than the second drive capability.

17. The pixel driving method according to claim 15, wherein the first pixel voltages are greater than a common voltage, the second pixel voltages are lower than the common voltage, the first drive capability is lower than the second drive capability when a frame rate of the display apparatus is greater than or equal to 120 Hertz, and the first drive capability is equal to the second drive capability when the frame rate of the display apparatus is less than 120 Hertz.

18. The pixel driving method according to claim 15, wherein the step of providing the data lines to transmit the first pixel voltages and the second pixel voltages to the pixels comprises:
in a first frame period, providing, via the data channels, the first pixel voltages to the pixels through a plurality of first data lines of the data lines respectively according to the polarity signal and the frame switching signal, and providing, via the data channels, the second pixel voltages to the pixels through a plurality of second data lines of the data lines respectively according to the polarity signal and the frame switching signal; and
in a second frame period following the first frame period, providing, via the data channels, the second pixel voltages to the pixels through the first data lines respectively according to the polarity signal and the frame switching signal, and providing, via the data channels, the first pixel voltages to the pixels through the second data lines respectively according to the polarity signal and the frame switching signal, wherein the first data lines are different from the second data lines.

19. The pixel driving method according to claim 18, wherein the first data lines and the second data lines are a plurality of odd data lines and a plurality of even data lines respectively.

20. The pixel driving method according to claim 15, wherein the pixels to which each of the data lines is coupled are located in two columns of pixels, and the pixels to which the data lines correspond are located in different rows and are not adjacent to each other.

21. The pixel driving method according to claim 15, wherein the pixels to which each of the data lines is coupled are located in four columns of pixels, the pixels located in the same row among the pixels to which the data lines correspond are adjacent to each other, and the pixels located in different rows among the pixels to which the data lines correspond are not adjacent to each other.
